(19) United States
(12) Patent Application Publication
(10) Pub. No.: US 2008/0068277 A1
(43) Pub. Date: Mar. 20, 2008

(54) Antenna apparatus

(75) Inventors: Takeshi Iizuka, Katagami-shi (JP); Junichi Noro, Akita-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsumi Electric Co. Ltd., Tama-shi (JP)

(21) Appl. No.: 11/880,663

(22) Filed: Jul. 24, 2007

(30) Foreign Application Priority Data
Sep. 15, 2006 (JP) 2006-251243

(51) Int. Cl. H01Q 1/02

(52) U.S. Cl. 343/841

(57) ABSTRACT

Disclosed an antenna apparatus comprising: an antenna element including a receiving section to receive an electric wave and a GND pattern; a circuit substrate including an amplifier circuit to amplify an input signal from the antenna element, the amplifier circuit formed on the circuit substrate; a shield cover to shield the amplifier circuit on the circuit substrate from a disturbing wave, the shield cover covering the amplifier circuit; and a grounding member attached to the GND pattern of the antenna element to enclose the shield cover in a separated state from the shield cover.

### BACKGROUND OF THE INVENTION

1. Field of the Invention

The present invention relates to an antenna apparatus, and more particularly to an antenna apparatus used for receiving electric waves of a global positioning system (GPS), a satellite radio, and the like.

2. Description of Related Art

Various antenna apparatus were developed, for example, as an antenna apparatus to be used for an in-car GPS system, which was spread as a positioning system, and an antenna apparatus to be used for in-car or a in-home fixed type satellite radio, which was put to practical use in US (see, for example, Japanese Patent Application Laid-Open Publications No. 2005-110007, No. 2004-72320, and No. 2004-228357).

In these antenna apparatus, as an antenna apparatus 100 illustrated in FIGS. 4A, 4B, and 5, a circuit substrate 103 is, for example, stuck on the back of an antenna element 102 having a patch type receiving surface 101 receiving electric waves. A not shown amplifier circuit amplifying a signal input from the antenna element 102 is formed on the surface on the opposite side of the circuit substrate 103 to the antenna element 102, and the surface on which the amplifier circuit is formed is covered by a substantially box-like shield cover 104 shielding the amplifier circuit from disturbing waves from the outside.

Incidentally, the receiving surface 101 is drawn to be thicker than the actual thickness thereof in FIG. 4A. Moreover, FIG. 5 shows the circuit substrate 103, the shield cover 104, and the coaxial cable 106 in the case where the antenna apparatus 100 of FIG. 4 is turned upside down, and omits to show the antenna element 102 and the like.

An input pin 105 penetrates the antenna element 102 and the circuit substrate 103 perpendicularly to them, and one end side of the input pin 105 is electrically connected to the receiving surface 101 of the antenna element 102 by soldering. Moreover, the other end side of the input pin 105 is electrically connected to the amplifier circuit on the circuit substrate 103 by being soldered to it to form an input section 103a. The input pin 105 allows an electric wave signal received by the receiving surface 101 of the antenna element 102 to be inputted to the amplifier circuit of the circuit substrate 103.

Moreover, the coaxial cable 106 is inserted into the shield cover 104. The core wire 106a of the coaxial cable 106 is electrically connected to the amplifier circuit on the circuit substrate 103 by being soldered to it, and the connection portion constitutes an output section 103b of the amplifier circuit. The coaxial cable 106 supplies driving power to the amplifier circuit through the core wire 106a thereof, and outputs a signal that has been received by the antenna element 102 and amplified by the amplifier circuit.

Moreover, the shield cover 104 also functions as the ground (GND), and a tongue flap 104b is formed by being bent from the base surface 104a of the shield cover 104 to the side of the coaxial cable 106. The tongue flap 104b is electrically connected to the outer conductor 106b of the coaxial cable 106 by being soldered to the outer conductor 106b, and thereby the shield cover 104 is set to the GND potential through the tongue flap 104b. The amplifier circuit is grounded through the shield cover 104.

In the antenna apparatus like this, as shown in an enlarged view of FIG. 4B, a GND pattern 107 stuck on almost the whole area of the antenna element 102 on the side of the circuit substrate 103 and a GND pattern 108 provided on almost the whole area of the circuit substrate 103 on the side of the antenna element 102 are stuck together with an adhesive member 109, such as a double-coated adhesive tape, and the antenna element 102 and the circuit substrate 103 are thereby bonded together.

In this case, the GND pattern 108 of the circuit substrate 103 also functions as the GND pattern of the antenna element 102, and the GND pattern 108 receives the supply of the GND potential from the shield cover 104 to provide the GND level to the antenna element 102.

However, if the miniaturization of the circuit substrate 103 is aimed in order to reduce the cost of the antenna apparatus 100 like this, the area of the GND pattern 108 of the circuit substrate 103 reduces, and the grounding efficiency of the antenna element 102 lowers, so that the grounding of the antenna element 102 becomes insufficient. Consequently, there was a problem of causing deterioration of the total gain in the antenna apparatus 100.

### SUMMARY OF THE INVENTION

The present invention was made under the situation as above. An object of the invention is to provide an antenna apparatus capable of keeping the total gain thereof without lowering the grounding efficiency of an antenna element even if a circuit substrate is miniaturized.

In order to attain the object mentioned above, according to the first aspect of the invention, an antenna apparatus includes: an antenna element including a receiving section to receive an electric wave and a GND pattern; a circuit substrate including an amplifier circuit to amplify an input signal from the antenna element, the amplifier circuit formed on the circuit substrate; a shield cover to shield the amplifier circuit on the circuit substrate from a disturbing wave, the shield cover covering the amplifier circuit; and a grounding member attached to the GND pattern of the antenna element to enclose the shield cover in a separated state from the shield cover.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein:

FIG. 1A is a schematic sectional view showing the configuration of an antenna apparatus according to the present embodiment;

FIG. 1B is a partially enlarged view of the antenna apparatus according to the present embodiment;

FIG. 2 is a perspective view showing a shield cover, a metal ring, and the like, in the state in which the antenna apparatus shown in FIG. 1 is turned upside down;

FIG. 3A is a graph exhibiting the rates of gains in all directions in the case of using the antenna apparatus according to the present embodiment;

FIG. 3B is a graph exhibiting the rates of gains in the case of providing no metal ring;

FIG. 4A is a schematic sectional view showing the configuration of a conventional antenna apparatus;

FIG. 4B is a partially enlarged view of the conventional antenna apparatus; and

FIG. 5 is a perspective view showing a shield cover, and the like, in the state in which the antenna apparatus shown in FIGS. 4A and 4B is turned upside down.

### DETAILED DESCRIPTION OF THE INVENTION

In the following, the preferred embodiment of an antenna apparatus according to the present invention will be described with reference to the attached drawings.

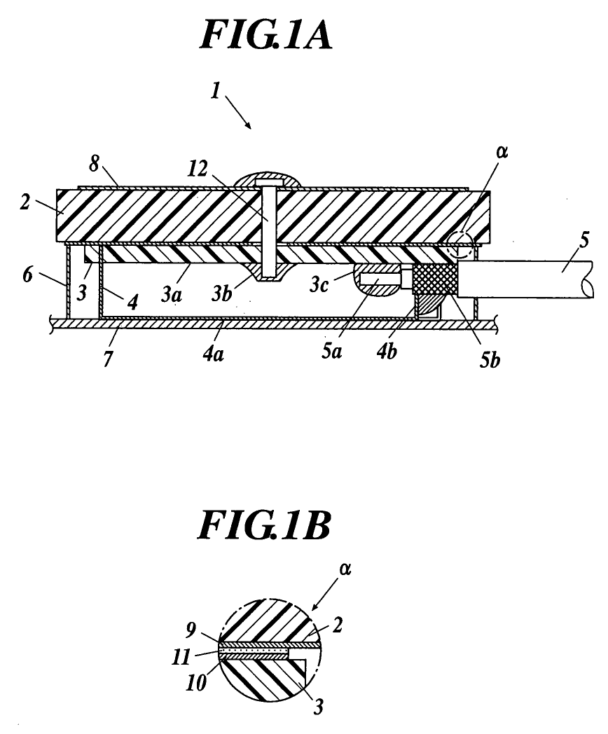

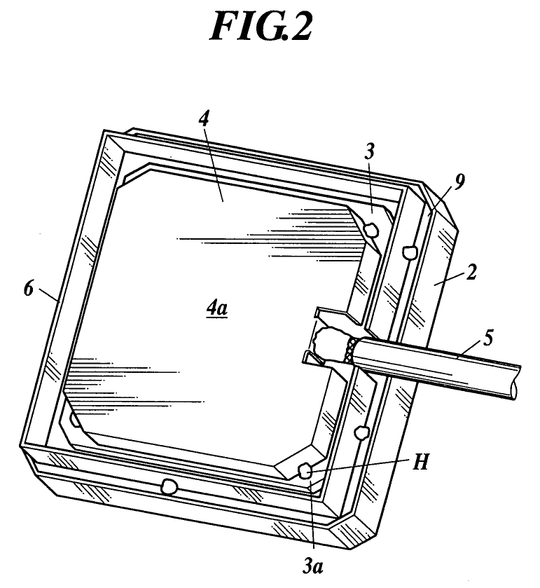

An antenna apparatus 1 according to the present embodiment includes an antenna element 2, a circuit substrate 3, a shield cover 4, a coaxial cable 5, a metal ring 6, a bottom cover 7, and the like, as shown in FIGS. 1A, 1B, and 2. Incidentally, FIG. 2 shows the antenna apparatus 1 of FIG. 1 in the state in which the antenna apparatus 1 is turned upside down, and omits the bottom cover 7 from being shown.

The antenna element 2 is made of a ceramic to be formed in a plate being slightly thick in the present embodiment. A patch type receiving surface 8 as a receiving section to receive electric waves is stuck on a surface of the antenna element 2 on one side. Incidentally, the receiving surface 8 is drawn to be thicker than the actual thickness thereof in FIG. 1A. Moreover, a GND pattern 9 of a metallic thin film is stuck on almost the whole surface of the antenna element 2 on the opposite side to the receiving surface 8 thereof except for an input pin 12 and the circumjacent part thereof as shown in the enlarged view of FIG. 1B.

The circuit substrate 3 is provided on the opposite surface side of the antenna element 2 to the receiving surface 8 thereof. A GND pattern 10 shaped into a metallic thin film is stuck on almost the whole surface of the circuit substrate 3 on the side of the antenna element 2 except for an input pin 12 and the circumjacent part thereof separately from the GND pattern 9 of the antenna element 2 as shown in the enlarged view.

In the present embodiment, the GND pattern 10 of the circuit substrate 3 and the GND pattern 9 of the antenna element 2 are stuck together with an adhesive member 11, such as a double-coated adhesive tape, and the antenna element 2 and the circuit substrate 3 are thereby bonded together. Moreover, the GND pattern 10 of the circuit substrate 3 functions as the GND pattern of the antenna element 2 together with the GND pattern 9 of the antenna element 2 itself.

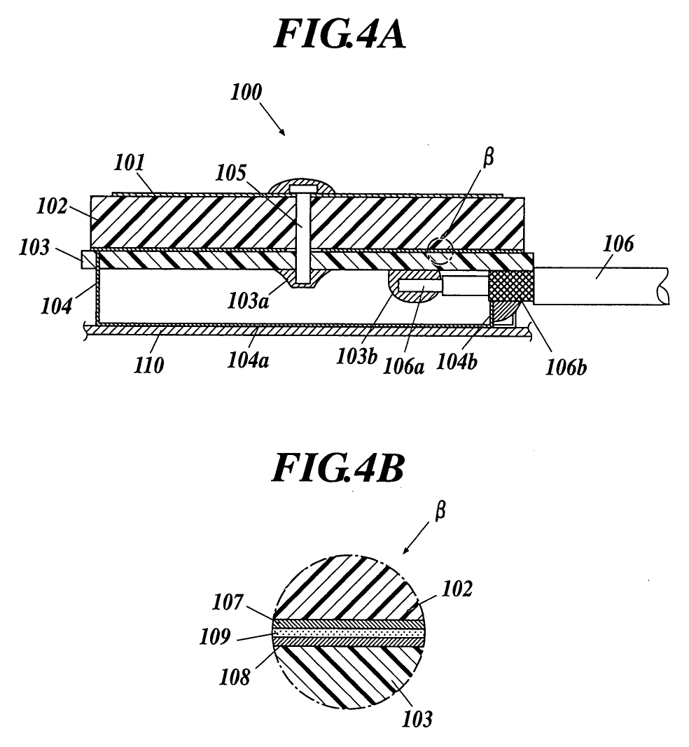

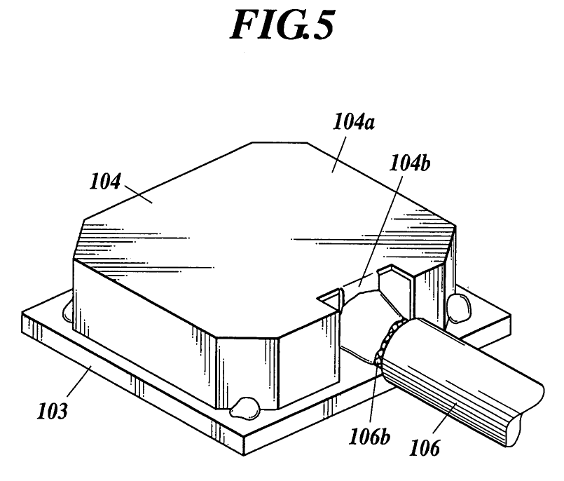

Incidentally, in the present embodiment, the circuit substrate 3 is smaller in size than that of the antenna element 2, and the area of the GND pattern 10 of the circuit substrate 3 is smaller than that of the GND pattern 9 of the antenna element 2. Consequently, the GND pattern 10 of the circuit substrate 3 functions as the GND pattern of the antenna element 2, however, the degree of the contribution thereof is smaller in comparison with the conventional antenna apparatus 1 shown in FIG. 4.

A not shown amplifier circuit amplifying an input from the antenna element 2 to output the amplified input is formed on the surface of the circuit substrate 3 on the opposite side to the antenna element 2, i.e., a circuit surface 3a. A not shown plurality of through-holes is formed in the circuit substrate 3 at suitable positions, and the ground of the amplifier circuit on the circuit surface 3a is connected to the GND pattern 10 on the back surface of the circuit substrate 3 through the through-holes.

The input pin 12 penetrates the receiving surface 8 of the antenna element 2 and the circuit surface 3a of the circuit substrate 3 perpendicularly to them at a predetermined position of the antenna element 2 and the circuit substrate 3. In the present embodiment, one end side of the input pin 12 is electrically connected to the receiving surface 8 of the antenna element 2 by soldering.

Moreover, the other end side of the input pin 12 is electrically connected to the amplifier circuit on the circuit substrate 3 by soldering, and the connection portion is used as an input section 3b of the amplifier circuit. The input pin 12 allows an electric wave signal received by the receiving surface 8 of the antenna element 2 to be inputted to the amplifier circuit of the circuit substrate 3 through the input section 3b.

The shield cover 4, which is made of a metal and formed in substantially the shape of a box, is attached to the circuit substrate 3 on the side of the circuit surface 3a so as to cover the circuit surface 3a, and the shield cover 4 shields the circuit surface 3a from disturbing waves arriving at the circuit surface 3a from the outside. Moreover, a base surface 4a of the substantially box-like shield cover 4 is arranged in parallel with the receiving surface 8 of the antenna element 2 and the circuit surface 3a of the circuit substrate 3.

As shown in the sectional view of FIG. 1A, a part of the shield cover 4 is formed as a projection to penetrate the circuit substrate 3, and thereby the shield cover 4 is positioned relative to the circuit substrate 3. Moreover, as shown in FIG. 2, in the present embodiment, the shield cover 4 is electrically connected to the ground of the amplifier circuit by being soldered with solder H on the circuit surface 3a of the circuit substrate 3.

Into the inside of the shield cover 4, the coaxial cable 5 is inserted. The core wire 5a of the coaxial cable 5 is electrically connected to the amplifier circuit on the circuit substrate 3 by soldering, and the connection potion is used as an output section 3c of the amplifier circuit. The coaxial cable 5 supplies driving power to the amplifier circuit through the core wire 5a, and outputs a signal received by the antenna element 2 and amplified by the amplifier circuit to be output through the output section 3c to the downstream side.

A tongue flap 4b is formed on the shield cover 4 so as to be bent from the base surface 4a of the shield cover 4 to the side of the coaxial cable 5, and the tongue flap 4b is soldered to the outer conductor 5b of the coaxial cable 5 to be electrically connected to the outer conductor 5b. Incidentally, the GND potential is supplied to the outer conductor 5b of the coaxial cable 5, and by the connection of the outer conductor 5b with the tongue flap 4b, the GND potential is supplied from the outer conductor 5b of the coaxial cable 5 to the amplifier circuit of the circuit substrate 3 through the tongue flap 4b and the shield cover 4.

The metal ring 6 as a grounding member is provided on the outer side of the side surface of the shield cover 4 in the state of being separated from the side surface of the shield cover 4 and the circumferential portion of the circuit substrate 3 so as to enclose the shield cover 4. The metal ring 6 is soldered to the GND pattern 9 of the antenna element 2 to be connected to the GND pattern 9.

In the present embodiment, the height of the metal ring 6 from the antenna element 2 is regulated so that the end thereof on the opposite side to the end thereof on the side of the antenna element 2 may be flush with the base surface 4a of the shield cover 4. When the tabular bottom cover 7 abuts on the shield cover 4, the bottom cover 7 simultaneously abuts on the end of the metal ring 6, too.

Incidentally, the height of the metal ring 6 from the antenna element 2 and the shape of the bottom cover 7 are not limited to those mentioned above, and any height and shape may be adopted as long as the height and the shape enable the bottom cover 7 to abut on the end of the metal ring 6 as well as on the base surface 4a of the shield cover 4.

The bottom cover 7 is made of a metal material, such as iron, and forms a part of a not shown antenna case protecting the antenna apparatus 1 by wrapping around the antenna apparatus 1 in the present embodiment. The bottom cover 7 abuts on the metal ring 6 to ground the metal ring 6, and grounds the GND pattern 9 of the antenna element 2 through the metal ring 6. The bottom cover 7 constitutes a base member of the present invention.

Moreover, in the present embodiment, the bottom cover 7 is brought into surface contact with the base surface 4a of the shield cover 4 to further improve the grounding efficiency of the shield cover 4.

Next, the operation of the antenna apparatus 1 according to the present embodiment will be described.

Driving power is supplied from the core wire 5a of the coaxial cable 5 to the amplifier circuit on the circuit substrate 3 of the antenna apparatus 1 through the output section 3c. Moreover, when the receiving surface 8 of the antenna element 2 receives a high frequency electric wave for the GPS or for a satellite radio, the electric wave signal is transmitted to the amplifier circuit through the input section 3b, and an electric wave signal amplified by the amplifier circuit is output from the output section 3c through the core wire 5a of the coaxial cable 5.

The amplifier circuit of the circuit substrate 3 is shielded from disturbing waves from the outside by the shield cover 4 made of a metal, which caver 4 covers the amplifier circuit. Moreover, the ground of the amplifier circuit is connected to the shield cover 4, as described above, and the amplifier circuit is grounded by receiving the supply of the GND potential from the outer conductor 5b of the coaxial cable 5 to the shield cover 4.

The GND potential is also supplied to the GND pattern 10 of the circuit substrate 3 through the through-holes of the circuit substrate 3, and the GND pattern 10 of the circuit substrate 3 is grounded, so that the GND level is provided to the antenna element 2.

Moreover, in the present embodiment, by bringing the bottom cover 7, which is made of a metal and is provided on the bottom of the antenna apparatus 1, and the base surface 4a of the shield cover 4 into surface contact, the grounding efficiency of the shield cover 4 is improved, and the grounding efficiency of the amplifier circuit is more improved.

However, as described above, the area of the GND pattern 10 of the circuit substrate 3 reduces owing to the miniaturization of the circuit substrate 3, and consequently the ground of the antenna element 2 cannot always obtained sufficiently only by the grounding of the GND pattern 10 of the circuit substrate 3.

In the present embodiment, the metal ring 6 abuts on the bottom cover made of a metal to be grounded, and the GND potential is directly supplied to the GND pattern 9 of the antenna element 2 through the metal ring 6. Consequently, it becomes possible to obtain the sufficient ground of the antenna element 2, and the deterioration of the total gain of the antenna apparatus 1 owing to the reduction of the area of the GND pattern 10 caused by the miniaturization of the circuit substrate 3 can be prevented.

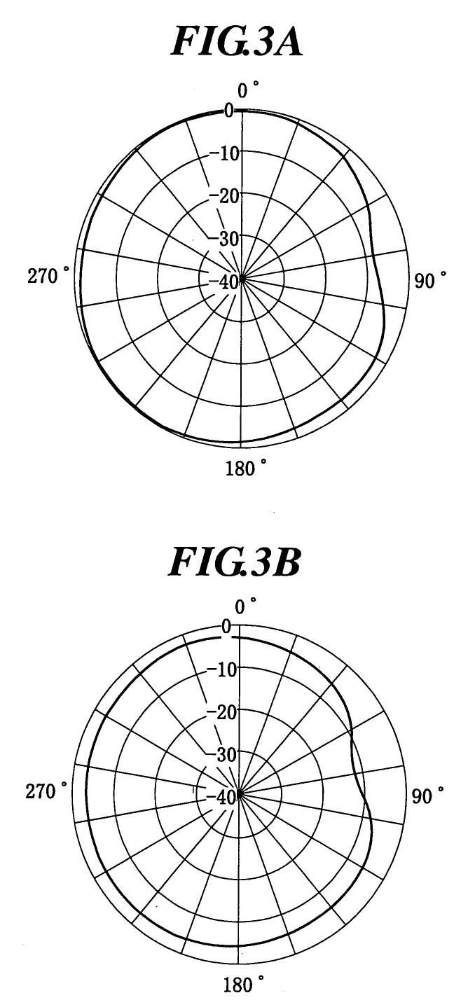

FIGS. 3A and 3B are graphs exhibiting the experimental results of the measurements of the gains of an electric wave of about 2.3 GHz in all directions, and exhibit the deficiencies to the standard antenna by percentages. The numerals in the graphs indicate the rates [%] of deficiencies. The well-known method was used as the measurement method of the gains.

Moreover, FIG. 3A shows the experimental results in the case where the antenna apparatus 1 according to the present embodiment was used, and FIG. 3B shows the experimental results in the case where the metal ring 6 was not used in the antenna apparatus 1 according to the present embodiment.

The deficiencies of the gains in all directions are suppressed to be very little in the antenna apparatus 1 according to the present embodiment shown in FIG. 3A in comparison with those of the case, shown in FIG. 3B, where the metal ring 6 is not provided, and consequently it is proved that the ground of the antenna element 2 can be sufficiently obtained by providing the metal ring 6, and that the deterioration of the total gain of the antenna apparatus 1 is efficiently suppressed.

Incidentally, there are the characteristic deficiencies of the gains in the neighborhood of 90° in FIGS. 3A and 3B, these deficiencies are caused by the structure of the antenna apparatus 1, and are not ones based on the peculiar characteristic of the antenna element 2.

As described above, by the antenna apparatus 1 according to the present embodiment, even if the GND pattern 10, which functions as the GND pattern of the antenna element 2, of the circuit substrate 3 reduces owing to the miniaturization of the circuit substrate 3, the lowering of the grounding efficiency of the antenna element 2 is effectively prevented by grounding the metal ring 6, which is the grounding member, and by grounding the GND pattern 9 itself of the antenna element 2 through the metal ring 6. Consequently, it becomes possible to supply the GND potential to the antenna element 2 sufficiently. The deterioration of the total gain of the antenna apparatus 1 is thereby effectively suppressed, and it becomes possible to keep the total gain of the antenna apparatus 1.

At that time, if the metal ring 6 is made to abut on the bottom cover 7, which is the base member and is made of a metal, the metal ring 6 is surely grounded, and it becomes possible to suitably supply the GND potential to the GND pattern 9 of the antenna element 2.

Moreover, if the metal ring 6 is formed in a pipe having a rectangular cross section along the shape of the side surface of the shield cover 4 like the present embodiment, the manufacturing of the metal ring 6 becomes easy, and the structure of the antenna apparatus 1 can be more miniaturized.

Incidentally, the metal ring 6 can be also formed in a curved surface. For example, if the metal ring 6 is formed in a cylinder, the metal ring 6 can be very easily formed. Moreover, if the metal ring 6 is formed to have the curved surface, the metal ring 6 can be formed in a shape required from the structure of the antenna apparatus 1.

Furthermore, if the ground of the antenna element 2 and the ground of the amplifier circuit on the circuit substrate 3 are independent of each other like the present embodiment, the antenna element 2 can surely receives electric waves without being influenced by the operations of the amplifier circuit.

Incidentally, although the description has been given to the antenna apparatus 1 including the patch type receiving surface 8 receiving the high frequency electric waves for the GPS or for a satellite radio on the surface of the antenna element 2 in the present embodiment, the configuration of the antenna element is not limited to the one including the patch type receiving surface, and any antenna element can be applied as long as the antenna element having a GND pattern.

According to the embodiment of the invention, an antenna apparatus includes: an antenna element including a receiving section to receive an electric wave and a GND pattern; a circuit substrate including an amplifier circuit to amplify an input signal from the antenna element, the amplifier circuit formed on the circuit substrate; a shield cover to shield the amplifier circuit on the circuit substrate from a disturbing wave, the shield cover covering the amplifier circuit; and a grounding member attached to the GND pattern of the antenna element to enclose the shield cover in a separated state from the shield cover.

Even if the GND pattern, which functions as the GND pattern of an antenna element, of a circuit substrate reduces owing to the miniaturization of the circuit substrate, a grounding member is attached to the whole circumference of the end of the GND pattern of the antenna element, and the ground of the GND pattern of the antenna element is thereby sufficiently enlarged to enable the efficient prevention of the lowering of the grounding efficiency of the GND pattern. Consequently, the deterioration of the total gain of the antenna apparatus is effectively suppressed to enable the keeping of the total gain of the antenna apparatus.

Preferably, the GND pattern of the antenna element is grounded through the grounding member.

By doing so, the grounding member is grounded to the GND pattern of the antenna element, and the GND pattern itself of the antenna element is grounded through the grounding member. The lowering of the grounding efficiency of the antenna element is thereby prevented, and the GND potential can be sufficiently provided to the antenna element. Consequently, the deterioration of the total gain of the antenna apparatus can be effectively suppressed, and the total gain of the antenna apparatus can be kept to reap the aforesaid advantage of the invention more surely.

Preferably, the antenna apparatus further comprising a base member abutting on the grounding member to ground the grounding member.

By doing so, if the grounding member is made to abut on the base member, the grounding member is surely grounded, and it becomes possible to supply the GND potential to the GND pattern of the antenna element suitably to enable the reaping of the advantages of each claim of the present invention.

Preferably, the grounding member is formed in a pipe having a rectangular cross section.

By doing so, if the grounding member is formed in a pipe having a rectangular cross section along the shape of the side surface of a shield cover, the manufacturing of the grounding member becomes easy, and the structure of the antenna apparatus can be more miniaturized.

Preferably, the grounding member is formed to have a curved surface.

By doing so, if the grounding member is formed to have a curved surface, such as a cylinder, the grounding member can be very easily formed. Moreover, if the grounding member is formed to have the curved surface, it becomes possible to form the grounding member to be in a shape required for the structure of the antenna apparatus.

Preferably, the antenna element and the amplifier circuit are grounded independently of each other.

By doing so, if the ground of the antenna element and the ground of an amplifier circuit on the circuit substrate are formed independently from each other, the antenna element can be surely receive electric waves without being influenced by the operations of the amplifier circuit.

The entire disclosure of Japanese Patent Application No. 2006-251243 filed on Sep. 15, 2006, including specification, claims, drawings and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. An antenna apparatus comprising:
an antenna element including a receiving section to receive an electric wave and a GND pattern;
a circuit substrate including an amplifier circuit to amplify an input signal from the antenna element, the amplifier circuit formed on the circuit substrate;
a shield cover to shield the amplifier circuit on the circuit substrate from a disturbing wave, the shield cover covering the amplifier circuit; and
a grounding member attached to the GND pattern of the antenna element to enclose the shield cover in a separated state from the shield cover.

2. The antenna apparatus according to claim 1, wherein the GND pattern of the antenna element is grounded through the grounding member.

3. The antenna apparatus according to claim 1, further comprising a base member abutting on the grounding member to ground the grounding member.

4. The antenna apparatus according to claim 1, wherein the grounding member is formed in a pipe having a rectangular cross section.

5. The antenna apparatus according to claim 1, wherein the grounding member is formed to have a curved surface.

6. The antenna apparatus according to claim 1, wherein the antenna element and the amplifier circuit are grounded independently of each other.
